(19) United States
(12) Patent Application Publication
(10) Pub. No.: US 2009/0167514 A1
(43) Pub. Date: Jul. 2, 2009

(54) Combined Radar Backup Assist and Blindspot Detector and Method

(76) Inventor: Brian Lickfelt, Powell, OH (US)

Correspondence Address: CERMAK KENEALY VAIDYA & NAKAJIMA LLP, 515 EAST BRADDOCK RD SUITE B, Alexandria, VA, 22314, US

(21) Appl. No.: 12/113,441

(22) Filed: May 1, 2008

Related U.S. Application Data
(60) Provisional application No. 61/018,445, filed on Dec. 31, 2007.

(51) Int. Cl. B60Q 1/00

(52) U.S. Cl. 340/435

(57) ABSTRACT

A system and method for detecting objects in the blind spot and behind a vehicle is provided. The system according to the disclosed embodiments includes a first and second sensor each having a long/narrow detection antenna and a short/wide detection antenna. The long/narrow detection antennae are activated when the vehicle is travelling in reverse so that objects behind the vehicle are detected when the vehicle is backing up. The short/wide detection antennae are activated when the vehicle is moving forward so that objects in the vehicle's blind spot are detected. When an object is detected, an alert is generated so that the vehicle operator is notified.

This application claims the priority benefit under 35 U.S.C. §119 of U.S. Provisional Patent Application No. 61/018,445 filed on Dec. 31, 2007, which is hereby incorporated in its entirety by reference.

### BACKGROUND

1. Field

The disclosed subject matter relates to system and method for detecting objects, and more particularly to a system and method for detecting various objects in a vehicle's blind spot when the vehicle is moving forward and various objects in the rear of the vehicle when the vehicle is backing up.

2. Brief Description of the Related Art

Drivers of vehicles typically have two main concerns when navigating through traffic. First, drivers are concerned with objects, including other vehicles, which cannot be seen because those vehicles are located in the driver's blind spot. This makes certain maneuvers, such as lane changes, risky because drivers may not be sure that adjacent lanes are open as they begin changing lanes. Similarly, drivers are often concerned that they may fail to see objects behind a vehicle when backing up the vehicle.

In order to address these concerns, most vehicles are equipped with a plurality of mirrors which allows the vehicle operator to view objects adjacent to and behind the vehicle. For example, mirrors are typically mounted on the sides of the vehicle, one positioned along a front edge of the driver side door and a second mirror positioned along a front edge of the passenger side door. These two mirrors provide a limited view of objects located adjacent the vehicle. In addition, a mirror is typically positioned along the top center portion of the front windshield. This mirror provides a limited view of objects located behind the vehicle.

The mirrors described above provide a driver with a limited ability to see objects adjacent to and/or behind the vehicle. However, even if the mirrors are used properly, blind spots exist which require additional care by the driver. In most cases, a vehicle operator must turn his or her head in order make sure that objects are not in the blind spot. Furthermore, in many cases, drivers to not take care to view all of the mirrors in which case they will miss objects adjacent to or behind the vehicle.

More recently, crash detection systems have been developed which employ a single sensor mounted along the centerline of the vehicle. The sensor may include one or more receiving antennae for long and narrow detection patterns. This conventional sensor system is not able to completely cover the vehicle blind spot region. To address this issue, systems have been developed which include a large number of sensors to detect objects in a vehicle blind spot. Nevertheless, such systems do not provide assistance during back up maneuvers. Thus, it would be desirable to provide a system and method having an optimum number of sensors which can be utilized for both detection of objects in the blind spot of a vehicle and objects directly behind the vehicle. Furthermore, it would be helpful to provide as small a number as sensors as possible carrying out the maximum amount of functionality.

### SUMMARY

The disclosed subject matter addresses at least some of the drawbacks in the conventional systems for detecting objects either behind or in the blind spot of a vehicle during driving forward and/or when backing up. A system and method for detecting objects is disclosed which includes two sensor, each sensor having two distinct detection antennae, one for long/narrow detection and the other for short/wide detection. According to an aspect of the disclosed subject matter, the long/narrow detection antennae are activated when the vehicle is backing up. According to another aspect of the invention, the short/wide detection antennae are activated when the vehicle is moving forward. Of course, each antenna can also be used to compliment the other's functionality as well (e.g., the back up short wide antennae can also be used to help the long range narrow antennae for blind spot detection during driving forward and vice versa).

According to an aspect of the disclosed subject matter, a tracking system for tracking objects is provided which includes a first radar sensor having a first long/narrow detection pattern antenna and a first short/wide detection pattern antenna, a second radar sensor spaced away from the first radar sensor, the second radar sensor including a second long/narrow detection pattern antenna and a second short/wide detection pattern antenna, wherein, the first and second long/narrow detection pattern antennae detect objects when a vehicle is backing up and wherein first and second short/wide detection pattern antennae detect objects when the vehicle is moving forward.

According to another aspect of the disclosed subject matter, the first and second sensors include a transceiver comprising a microwave radar device to detect the presence of an object within the transceiver range.

According to another aspect of the disclosed subject matter, the first and second long/narrow detection pattern antennae and the first and second short/wide detection pattern antennae are each configured to receive microwave signals which are reflected from objects located behind the vehicle. One or more transmit antennae can be provided to ‘flood’ the rear and possibly side of the vehicle with radio frequency (RF). In other words, transmit is basically always on. A signal is transmitted at a very wide angle, and at some distance, at least as far as the sensitivity of the receive antenna or antennae. In this manner, an object's location in the detection field is “illuminated” by the transmitted signal, and “seen” by the receive pattern.

According to another aspect of the disclosed subject matter, the tracking system includes a controller for generating an output signal to an alert circuitry when the controller receives an input signal from at least one of the first and second sensors indicating that an object was detected.

According to another aspect of the disclosed subject matter, a method for tracking objects is provided which includes generating a transmission signal to an area adjacent a vehicle. The method includes configuring an antennae to receive RF reflections from a first long/narrow detection pattern and a second long/narrow detection pattern for when a vehicle is traveling in reverse, and configuring an antennae to receive RF reflection from a first short/wide detection pattern and a second short/wide detection pattern for when a vehicle is traveling forward. The method further includes receiving a return wave signal from at least one detection pattern and generating an alert signal based upon the received return wave signal.

Still other aspects, features, and attendant advantages of the disclosed subject matter will become apparent to those skilled in the art from a reading of the following detailed description of embodiments constructed in accordance therewith, taken in conjunction with the accompanying drawings.

### BRIEF DESCRIPTION OF THE DRAWINGS

The disclosed subject matter will now be described in more detail with reference to exemplary embodiments of the apparatus and method, given only by way of example, and with reference to the accompanying drawings, in which:

FIG. 1 illustrates is a schematic plan view illustrating an example of a sensor arrangement for a tracking system according to the disclosed subject matter;

FIG. 2 shows an electrical schematic circuit diagram for the detection system according to an embodiment of the disclosed subject matter; and

FIG. 3 shows a block diagram of the object tracking system in accordance with an embodiment of the disclosed subject matter.

### DETAILED DESCRIPTION OF EXEMPLARY EMBODIMENTS

The disclosed subject matter provides a system and method for detecting objects in the blind spot of a vehicle when the vehicle is moving forward and behind the vehicle when the vehicle is backing up. Referring to the drawing figures, like reference numerals designate identical or corresponding elements throughout the several figures.

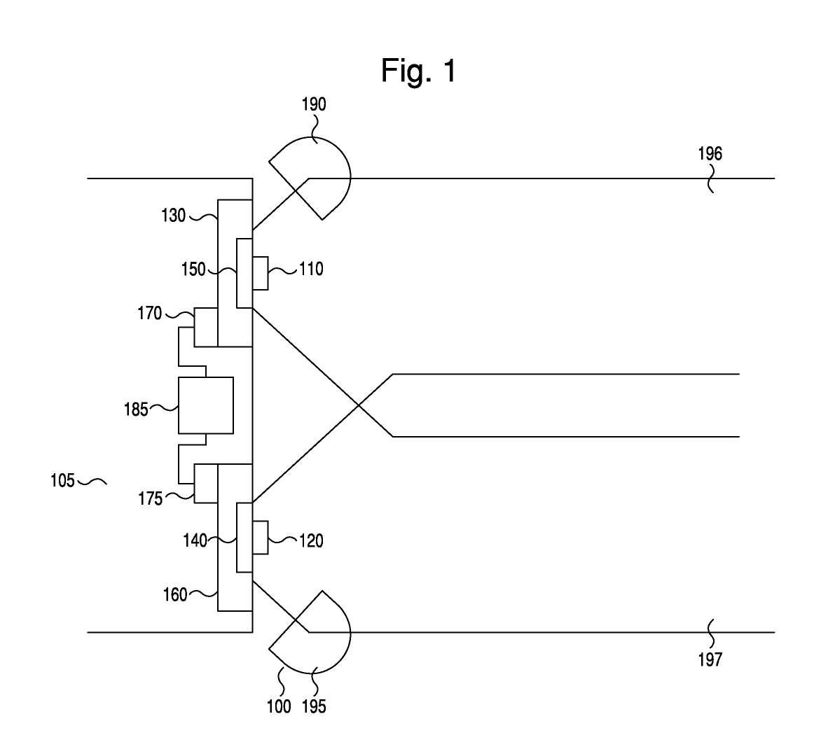

FIG. 1 is a plan view illustrating the geometry of a sensor arrangement for a vehicle tracking system according to the disclosed embodiments. FIG. 1 shows a vehicle 105 having an object detecting system 100 for detecting and tracking objects so as to prevent vehicle lane or object incursions caused by driver failure to see objects in the vehicle path. The system 100 can also detect objects in a vehicle blind spot when the vehicle is moving forward and detects objects immediately behind the vehicle when the vehicle is backing up.

FIG. 1 shows that the object detecting system 100 includes a first sensor 110 and an overlapping second sensor 120. The first and second sensors 110 and 120 are spaced away from each other and offset from the vehicle center line. The first sensor 110 includes a first antenna 130 and a second antenna 150. The second sensor 120 includes a first antenna 140 and a second antenna 160. The first antennae 130 and 140 have corresponding short/wide detection patterns 190 and 195 respectively. The second antennae 150 and 160 have corresponding long/narrow detection patterns 196 and 197. The detection patterns 190 and 195 may partially overlap while the detection patterns 196 and 197 may also partially overlap. As will be described later in greater detail, the first antennae 130 and 140 can be activated when the vehicle is moving forward, while the second antennae 150 and 160 can be activated when the vehicle is backing up. The antennae 130, 140, 150 and 160 may be constructed of any materials, such as a machined aluminum, etc., or may be realized as a PCB pattern/trace.

The first sensor 110 may include a first transceiver 170 having a microwave device for detecting the presence of an object. Similarly, the second sensor 120 may include a second transceiver 175 for also detecting the presence of an object. FIG. 1 also shows that the first sensor 110 and second sensor 120 are operatively coupled to an alert circuitry 185 for providing notifications to the driver.

In operation, when the vehicle is moving forward, the first and second transceivers 170 and 175 are activated to transmit electromagnetic radiation. The first and second transceiver 170 and 175 range can span the width of the vehicle and extends rearwardly. As the vehicle moves forward, the first antennae 130 and 140 are activated so that objects within the short/wide patterns 190 and 195 are detected. This includes objects in the driver's blind side. Thus, when the vehicle moves forward, reflected signals from an object within the transceiver's 170 and 175 range and within the first antenna patterns 190 and 195 are picked up. These reflected signals will be processed by the alert circuitry 185 to notify the driver that an object has been detected. The notification can take any form, including a warning sound delivered to the driver through the vehicle's existing sound system, or alternately through a designated speaker device within the vehicle cabin. The alert circuitry may include an audio or visual alarm device mounted in the interior of the passenger compartment so as to be audible or visible to the vehicle driver and passengers.

When the vehicle is moving in reverse (backing up), the second antennae 130 and 140 can be activated so that objects within the long/narrow patterns 196 and 197 are detected. This includes objects located directly behind the vehicle. Thus, when the vehicle is traveling in reverse, reflected signals from an object within the transceiver's 170 and 175 range and within the second antenna patterns 196 and 197 are picked up. These reflected signals will be processed by the alert circuitry 185 to notify the driver that an object has been detected. The notification can take any form, including a warning sound delivered to the driver through the vehicle's existing sound system, or alternately through a designated speaker device with the vehicle cabin.

It should be understood that FIG. 1 is schematic in nature and that the actual packaging of the sensor can be varied depending on many factors including design preference, ease of manufacture, operational benefits, etc. For example, alert circuitry 185 can be integrated into one of the sensors. In addition, the first antennae 130, second antennae 150, and transceiver 170 can all be integrated into the first sensor 110, or at least into the first sensor's housing structure. Likewise, the first antennae 140, second antennae 160, and transceiver 175 can all be integrated with second sensor 120. Thus, there is one less box or housing for a producer or supplier to have to package, and certain circuitry components could even be shared in this manner. For example, one sensor, 110 or 120 could be the master, which contains the alert logic. Allowing for integration of these sensors, transceivers and alert circuitry can provide other design benefits by saving space within the vehicle, and can provide operational benefits by simplifying the structures that are produced.

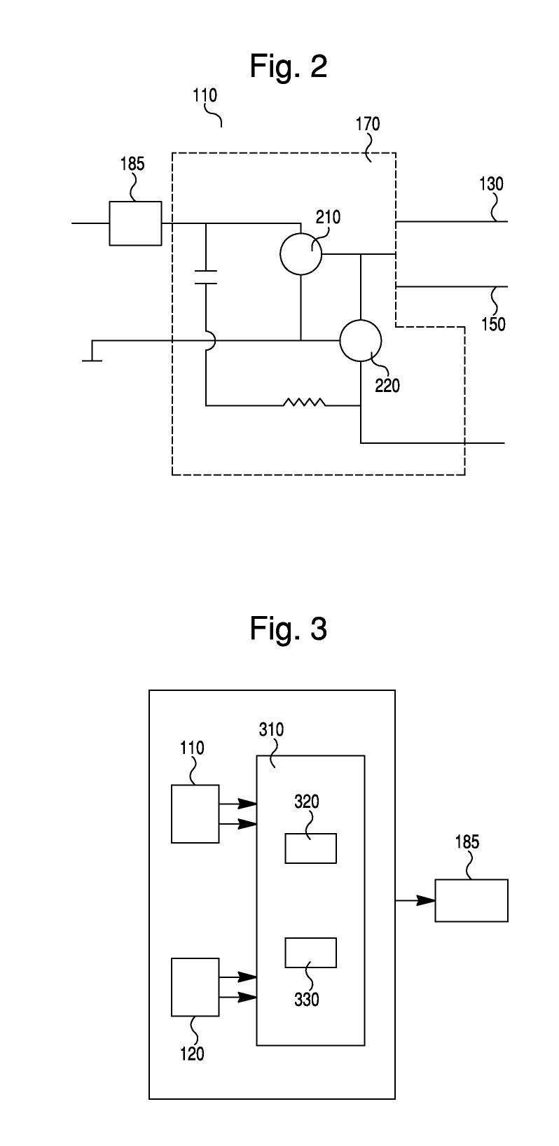

FIG. 2 shows an electrical schematic circuit diagram for one example of an alternate detection system according to an embodiment of the disclosed system. In FIG. 2, the first sensor 110 of FIG. 1 is illustrated. It should be understood that the circuit diagram of FIG. 2 is equally applicable to the second sensor 120 of FIG. 1. As shown in FIG. 2, the detection system may include the transceiver 170 and the first and second antennae 130 and 150. In one embodiment, the transceiver 170 may include a gunn diode 210 mounted in a waveguide cavity which acts as the transmitter and local oscillator, together with a schottky barrier mixer diode 220 for the receiver. Electromagnetic radiation transmitted from the gunn diode 210 is reflected back at either the antenna 130 or the antenna 150 by an object within the transceiver range. If the object is moving relative to the vehicle, the frequency shift of the wave reflected by the moving object is measured electronically and triggers activation of the alert circuitry 185. This type of system can be characterized as a Doppler radar system.

Of course, a continuous-wave (CW) radar system is also contemplated for use as the radar system for the disclosed subject matter. In this case, known and stable frequency CW radio energy is transmitted and then received from any reflecting objects. The CW radar system is always transmitting, always receiving. It also has the ability to switch between receive antennas to cover the intended detection pattern.

FIG. 3 shows a block diagram of the object tracking system in accordance with an embodiment of the disclosed subject matter. FIG. 3 shows first and second sensors 110 and 120 and a controller 310. The controller 310 can include a microprocessor based controller having a microprocessor 320 and a memory 330. Memory 330 includes a random access memory (RAM), read-only memory (ROM) and an electronically erasable programmable read-only memory (EEPROM). The controller 310 may include off the shelf components and may be dedicated to detecting and tracking an object and alerting a driver when objects are detected. In one embodiment, the controller 310 will receive input signals from the sensors 110 and 120 indicating whether an object has been detected when the vehicle is moving forward or when the vehicle is moving backwards. The controller 310 may generate an output signal to the alert circuitry 185 so that the driver is then alerted to the detected object.

The first antennae 130 of the first sensor 110 can be configured to detect RF that reflects back from objects located within the short/wide receive pattern 190. The second antennae 150 of the first sensor 110 can be configured to detect RF that reflects back from objects located within the long/narrow receive pattern 196. The second sensor 120 can be similarly constructed and configured. When viewed from a top of a vehicle, an emission pattern (or transmission area) can be relatively wide and long such that the rear and side(s) of a vehicle are illuminated by radio frequency RF emission from one or both of the sensors 110 and/or 120. In particular, the emission pattern can be configured to include the short/wide receive patterns 190, 195 and the long/narrow receive patterns 196, 197 therein. As indicated above, the specific packaging or housing for the sensors 110 and/or 120 and alert circuitry can be varied. For example, the alert circuitry could be combined in the housing for either or both of the first and second sensors 110 and/or 120. In addition, depending on the particular vehicle application, it may even be possible to combine the first and second sensors 110 and/or 120 and the alert circuitry 185 into a single housing.

It should be noted that several of the disclosed elements that make up the system for detecting objects can be varied without departing from the spirit and scope of the presently disclosed subject matter. For example, it should be understood that a variety of sensor devices may be incorporated into the system, including, microwave Doppler radar sensors, CW sensor systems, and other types of known radar sensors, video imaging cameras and laser sensors, all of which are capable of detecting the presence of an object and tracking the relative movement of a detected object. Other antennae patterns can also be used to cover the area around the vehicle. For example, the short/wide pattern and long/narrow patterns as shown in the Figures are for exemplary purposes, but could be modified to best work in a given application for a particular vehicle.

While the invention has been described in detail with reference to exemplary embodiments thereof, it will be apparent to one skilled in the art that various changes can be made, and equivalents employed, without departing from the scope of the invention. The foregoing description of embodiments of the invention has been presented for purposes of illustration and description. It is not intended to be exhaustive or to limit the invention to the precise form disclosed, and modifications and variations are possible in light of the above teachings or may be acquired from practice of the disclosed subject matter. The embodiments were chosen and described in order to explain the principles of the invention and its practical application to enable one skilled in the art to utilize the invention in various embodiments as are suited to the particular use contemplated. It is intended that the scope of the invention be defined by the claims appended hereto, and their equivalents. The entirety of each of the aforementioned related art documents is incorporated by reference herein.

What is claimed is:

1. A tracking system for tracking objects located adjacent a vehicle, comprising:
a first radar sensor having a first long/narrow detection pattern antenna configured to detect objects located within a first long/narrow detection pattern located at a rear of the vehicle, and a first short/wide detection pattern antenna configured to detect objects located within a first short/wide detection pattern located at the rear of the vehicle, the first long/narrow detection pattern being longer and narrower than the first short/wide detection pattern;
a second radar sensor spaced away from the first radar sensor, the second radar sensor including a second long/narrow detection pattern antenna configured to detect objects located within a second long/narrow detection pattern located at the rear of the vehicle, and a second short/wide detection pattern antenna configured to detect objects located within a second short/wide detection pattern located at the rear of the vehicle, the second long/narrow detection pattern being longer and narrower than the second short/wide detection pattern, wherein
the first and second long/narrow detection pattern antennae are configured to detect objects when the vehicle is backing up and wherein the first and second short/wide detection pattern antennae are configured to detect objects when the vehicle is moving forward.

2. The tracking system according to claim 1, wherein the first and second sensors include a transceiver comprising a microwave radar device to detect the presence of an object within the transceiver range.

3. The tracking system according to claim 1, wherein the first and second long/narrow detection pattern antennae and the first and second short/wide detection pattern antennae are each configured to receive a microwave signal radiated rearward from the vehicle in a pattern that spans a rear width of the vehicle and which is reflected from at least one object located behind the vehicle.

4. The tracking system according to claim 1, further comprising a controller for generating an output signal to an alert circuitry when the controller receives an input signal from at least one of the first and second sensors indicating that an object was detected.

5. The tracking system according to claim 4, wherein the alert circuitry generates a warning signal to a driver of a vehicle that an object has been detected.

6. The tracking system according to claim 4, wherein the warnings signal is one of an audible alert and a visual alert.

7. The tracking system according to claim 1, wherein the first long/narrow detection pattern has a longitudinal axis that extends substantially parallel to a drive axis of the vehicle and the second long/narrow detection pattern has a longitudinal axis that extends substantially parallel to the drive axis of the vehicle.

8. The tracking system according to claim 1, wherein the first short/wide detection pattern has a longitudinal axis that extends substantially perpendicular to a drive axis of the vehicle and the second short/wide detection pattern has a longitudinal axis that extends substantially perpendicular to the drive axis of the vehicle.

9. The tracking system according to claim 1, wherein the first and second sensors are mounted on a rear section of the vehicle and are spaced away from a center line of the vehicle.

10. The tracking system according to claim 1, wherein the system includes a controller configured to activate the first and second long/narrow antennae when the vehicle is moving in reverse direction.

11. The tracking system according to claim 1, wherein the system includes a controller configured to activate the first and second short/wide antenna when the vehicle is moving in a forward direction.

12. The tracking system according to claim 1, wherein at least one of the short/wide antennae is directed toward a driver's side of the vehicle.

13. The tracking system according to claim 1, wherein at least one of the long/narrow antennae is directed toward the center line of the vehicle.

14. A system for tracking objects located about a vehicle, comprising:
means for generating and transmitting a radio frequency signal rearward of the vehicle;
means for sensing radio signals from a first long/narrow detection pattern and a second long/narrow detection pattern when the vehicle is traveling in reverse;
means for sensing radio signals from a first short/wide detection pattern and a second short/wide detection pattern when the vehicle is traveling forward, the first short/wide detection pattern being shorter and wider than the first long/narrow detection pattern and the second short/wide detection pattern being shorter and wider than the second long/narrow detection pattern; and
means for generating an alert signal based upon the received return wave signal.

15. A method for tracking an object located about a vehicle, comprising:
generating and transmitting a radio frequency pattern;
sensing a first long/narrow detection pattern and a second long/narrow detection pattern when the vehicle is traveling in reverse;
sensing a first short/wide detection pattern and a second short/wide detection pattern when the vehicle is traveling forward, the first short/wide detection pattern being shorter and wider than the first long/narrow detection pattern and the second short/wide detection pattern being shorter and wider than the second long/narrow detection pattern;
receiving a return wave signal from an object located in at least one detection pattern; and
generating an alert signal based upon the received return wave signal.

16. The method of claim 15, further comprising:
providing a first sensor configured to sense the first short/wide detection pattern;
providing a second sensor configured to sense the second short/wide detection pattern;
locating the first sensor and second sensor at a rear section of the vehicle and spacing the first sensor and second sensor away from and on opposite sides of a center line of the vehicle.

17. A vehicle tracking system for tracking objects, comprising:
a vehicle having a vehicle longitudinal axis center line;
a first radar sensor having a first long/narrow detection pattern antenna and a first short/wide detection pattern antenna each spaced from the vehicle longitudinal axis center line, the first long/narrow detection pattern antenna configured to detect an object located within a first long/narrow detection pattern, and the first short/wide detection pattern antenna configured to detect an object located within a first short/wide detection pattern, the first short/wide detection pattern being shorter and wider than the first long/narrow detection pattern;
a second radar sensor spaced away from the first radar sensor, the second radar sensor including a second long/narrow detection pattern antenna and a second short/wide detection pattern antenna each spaced from the vehicle longitudinal axis center line,
wherein, the first and second long/narrow detection pattern antennae are configured to detect objects when a vehicle is backing up and wherein the first and second short/wide detection pattern antennae are configured to detect objects when the vehicle is moving forward.
